(19) United States
(12) Patent Application Publication
(10) Pub. No.: US 2011/0238983 A1
(43) Pub. Date: Sep. 29, 2011

(54) NETWORK INTEGRITY MAINTENANCE

(75) Inventors: Jeffrey Bruce Lotspiech, Henderson, NV (US); Kevin Snow McCurley, San Jose, CA (US); Florian Pestoni, Mountain View, CA (US)

(73) Assignee: INTERNATIONAL BUSINESS MACHINES CORPORATION, Armonk, NY (US)

(21) Appl. No.: 13/153,603

(22) Filed: Jun. 6, 2011

Related U.S. Application Data
(62) Division of application No. 10/691,361, filed on Oct. 21, 2003, now abandoned.

(51) Int. Cl. H04L 29/06

(52) U.S. Cl. 713/165

(57) ABSTRACT

A device removal system securely removes an item of content or a device from a content-protected home network. An authorization table maintains a list of devices in the content-protected home network in addition to removed devices. The authorization table also maintains a list of deleted content. Through management of various cryptographic keys and techniques, devices and content will not play on a content-protected home network after they have been removed. A secret network ID reduces the possibility of unauthorized playing of content on the content-protected home network. A web server may join the content-protected home network as a device, providing backup for the secret network ID. Otherwise, the device manufacturer will provide the secret network ID in case of a device failure. Storing a verification value in each device ensures integrity of critical cryptographic values. This verification value is compared to network values to ensure network values have not been corrupted.

### CROSS REFERENCE TO RELATED APPLICATIONS

This application is a divisional of U.S. patent application Ser. No. 10/691,361, filed Oct. 21, 2003, the entire contents of which are incorporated herein by reference.

### FIELD OF THE INVENTION

The present invention generally relates to a system for encrypting copyrighted content such as music or movies. More specifically, the present invention pertains to a network of electronic devices within a home that is structured to protect such content from unauthorized use or distribution.

### BACKGROUND OF THE INVENTION

The entertainment industry is in the midst of a digital revolution. Music, television, and movies are increasingly becoming digital, offering new advantages to the consumer in quality and flexibility. At the same time, since digital data can be perfectly and quickly copied, the digital revolution also comprises a threat. If consumers may freely copy entertainment content and offer that content on the Internet, the market for entertainment content would evaporate.

To solve this problem, several content protection schemes have been devised and are in wide use in the market. For example, DVD video is protected by the Content Scrambling System (CSS), DVD audio is protected by Content Protection for Pre-recorded Media (CPPM), digital video and audio recorders are protected by Content Protection for Recordable Media (CPRM), and digital busses are protected by Digital Transmission Content Protection (DTCP). All these schemes are based on encryption of the content. The device manufacturer is given cryptographic keys to decrypt the content, and in return is obligated by the license to follow a set of rules limiting the physical copies that can be made from a single piece of content.

However, physically limiting the content can sometimes cause an awkward experience for consumers in their normal usages. Recently, an alternative approach has been proposed: instead of limiting the physical copies of a piece of content, limit the number of devices that may be permitted to play it. Variously called the authorized domain or the personal digital domain, this approach attempts to offer the maximal user flexibility while still protecting the rights of the content owners.

Many companies have proposed technologies for the authorized domain. For example, Thomson has proposed a technology called SmartRight. Cisco has proposed a technology called OCCAM. IBM has proposed a technology for a content-protected home network called extensible content protection (xCP) cluster protocol.

Compared to every other proposal for the authorized domain, the content-protected home network, or xCP, is unique. xCP is based on a cryptographic technology called broadcast encryption. Broadcast encryption, as its name implies, is one-way. Devices do not need to have a conversation to establish a common key. Recent advances in broadcast encryption have made it as powerful as public-key cryptography in terms of revocation power.

Because of its one-way nature, broadcast encryption is inherently suited to protect content on storage. In terms of the authorized domain, the content-protected home network has several advantages. The content-protected home network is completely independent of the home network protocol (e.g., wireless, Ethernet, Firewire). In addition, the content-protected home network protects the user's content regardless of where it is located, including remotely on an Internet “locker”.

Devices are formed into networks; devices within this network share a common block of data, called a key management block. The key management block is the fundamental element of the broadcast encryption scheme. Each device in the network has a set of device keys that allow the device to process the key management block in a manner unique to the device. However, all the devices in the network end up with the same answer, called the management key. Devices that attempt to circumvent the broadcast encryption, also known as circumvention devices, may attempt to process the key management block using their device keys but cannot obtain the correct value.

In the conventional content-protected home network, calculating the management key is a precursor to calculating the binding key. The binding key is the key that protects the content in a given network or cluster of devices. The binding key is the cryptographic hash of the management key, the network binding ID, and the list of the devices in the network, called the authorization table. Because the management key is part of the binding key calculation, circumvention devices cannot calculate the binding key.

The devices in the xCP network comprise a common key management block and a common idea of which other devices are on the xCP network by means of an authorization table. Each device maintains its own copy of a network identifier called the binding identifier. These entities are bound together cryptographically.

The management key from the key management block, the binding identifier, and a hash of the authorization table are used to calculate the common network key, called the binding key. The binding key protects all content in the content-protected home network. Certain efficiencies are provided through a level of indirection: the binding key encrypts the title keys for each piece of content, and the title keys are used to actually encrypt the content itself.

Devices within the content-protected home network can calculate the binding key without having a conversation with any other device on the network. This strength of the content-protected home network contributes to flexibility regarding network transport. The key management block and the authorization table are simple files in the network; duplicates of the key management block and authorization table might even be in the device's local persistent storage.

The device knows the binding ID and can obtain the key management block and the authorization table; consequently, the device has everything it needs cryptographically to decrypt any piece of content in the network. However, the usage rules that are cryptographically bound to that content may forbid the device from performing certain operations with the content. Consequently, the device will not perform the forbidden action because it is compliant: for example, a recorder would not record content encoded “do not copy”.

For example, a user wants to make an unauthorized copy of some content for a friend. If the user simply brings the copy over to his friend's house and loads it up on his friend's content-protected home network, the content will not play. The content-protected home network of the friend is using a different binding key; the devices within the content-protected home network of the friend will not be able to correctly calculate the title keys on this foreign content.

A more sophisticated user might bring his network's key management block and his network's authorization table with the content to the friend's content-protected home network. The key management block and network authorization table are just simple files. The user may also know the binding identifier of his content-protected home network even though this is not easy to determine. The user's content will still not play on the content-protected home network of his friend. The compliant devices in his friend's content-protected home network will observe that they are not on the authorization table provided by the user and refuse to play the content, even though the devices in the friend's content-protected home network can correctly calculate the binding key.

Although the xCP content-protected home network has proven to be quite effective for its intended purpose, it would be desirable to present additional improvements. Further discussions with content owners and consumer groups have illustrated several user scenarios that xCP either did not address, or addressed inefficiently. For example, people get divorced and wish to divide the devices in a home network, children go away to college and wish to take one or more devices with them, and people want to re-sell devices they have purchased.

Consequently, it is necessary to present a method for conveniently removing a device from a network or cluster. Likewise, users want a way to sell individual pieces of content. At the same time, content owners wish to ensure the seller is unable to retain a copy of the same content. What is therefore needed is a system, a computer program product, and an associated method for securely removing a device from a content-protected home network. The need for such a solution has heretofore remained unsatisfied.

### SUMMARY OF THE INVENTION

The present invention satisfies this need, and presents a system, a computer program product, and an associated method (collectively referred to herein as “the system” or “the present system”) for securely removing an item of content or a device from a content-protected home network (also referred to as xCP).

The present system provides a mechanism for removing a device from a user's content-protected home network, using an authorization table. The device is tentatively marked as being removed, which then automatically acknowledges that is has been removed. An automatic confirmation is recorded in the authorization table that the device has been removed, but the device remains listed in the authorization table. The authorization table has now changed, and consequently, the binding key is recalculated for all the devices and content in the network.

The present system provides a mechanism for the removal of content from the user's content-protected home network. In one embodiment of the present system, a list of content that has been removed from the network is maintained in the authorization table. This allows the user to sell or dispose of content they no longer want with full rights to the purchaser, because the content-protected home network will not play the content that has been marked as removed.

The binding key is changed because the authorization table has been changed. The binding key fundamentally protects all the content in the content-protected home network. Should the user keep a copy of that content that he or she has sold or given away, it would have been encrypted with the old binding key, and devices would not be able to correctly decrypt it using the new binding key.

Although in a preferred embodiment, the list of devices and content that have been removed from the network are included in the authorization table, it would be obvious to one of ordinary skill in the art that this information may be stored in many other places, including, for example, other files on the network. The present invention contemplates including this information in the binding key calculation.

The present system provides a content-protected home network with a secret binding ID. In a conventional content-protected home network, the binding ID is not secret. Consequently, a hacker or adversary may be able to create a circumvention device that would play any content in any content-protected home network, until a new key management block is released and implemented by the users. The binding ID of the present system is determined and installed by the device manufacturer. In a preferred embodiment, only the manufacturer knows the secret binding ID.

Each device has its own secret binding ID that it is prepared to use if it is the first device in the network. The first device installed in a content-protected home network uses its secret binding ID as the network ID for the content-protected home network. Devices that join the network later accept the secret binding ID established by the first device, and ignore their own. The secret binding ID is shared among all the devices in the content-protected home network. Should the device fail, the other devices in the content-protected home network will remember the secret binding ID, allowing the insertion of a new device in the content-protected home network and allowing all content in the content-protected home network to be played.

However, a content-protected home network may comprise only one device. If the device fails, the user has no means for restoring his content-protected home network or his content. The present system provides a mechanism for restoring a secret binding ID in the case of a device failure. In one embodiment, the manufacturer provides the secret binding ID to the user based on a secret relationship between the serial number of the device and the secret network ID.

In another embodiment, a web server that is delivering content such as movies or music to the home becomes part of the content-protected home network. The web server encrypts the content with the secret binding ID for that particular content-protected home network. The web server joins the content-protected home network using the conventional method of the xCP cluster protocol. The web server now remembers the secret binding ID in a manner similar to other devices in the content-protected home network. Consequently, the user will not lose access to content he has purchased in the event of a device failure.

The present system provides a method to check the integrity of critical files using secure read-write storage within each device to store, for example, the key management block and the authorization table. In the conventional xCP cluster protocol, a device did not have any secure read-write storage, making the content-protected home network susceptible to attacks by adversaries or hackers. The purpose of the secure read-write storage is to ensure that the files in the network such as the key management block and the authorization table have not been changed on the device. The secure read-write storage provides an integrity check for critical files. In one embodiment, this integrity check is based on storing the binding key in the device's secure storage because the binding key is a result of a calculation involving the key management block and the authorization table.

The present system provides a mechanism for updating the key management block in a content-protected home network while minimizing the storage required by the key management block. The conventional xCP cluster protocol updates the key management block on a regular basis. As circumvention devices appear, the key management block lists those devices to prevent them working on the content-protected home network. Updated key management blocks were merged with the old key management block, doubling the size of the key management block. Consequently, the key management block grew steadily larger and larger, and it took a relatively complicated protocol among the devices to let it become small again.

The present system updates key management blocks by selecting the most recent key management blocks. In one embodiment, the key management blocks are digitally signed and cannot be modified by an adversary or hacker. Consequently, the devices simply check the signature to make sure the block is intact. The device can then trust the media key block and the date or version number in the block. In another embodiment, the device analyzes the key management block to deduce the age of the block based on the number of devices revoked it.

As circumvention devices are discovered, the license agency managing the xCP system issues new key management blocks, revoking those circumvention devices so they cannot be used in a content-protected home network. In a comparison between two key management blocks, the key management block revoking more devices will be more recent. With either embodiment, the device chooses one key management block and the size of the key management block does not increase. All devices in the network are implementing the same logic, so they will all accept the newly proposed key management block as more recent.

The present system may also provide a mechanism for restricting content to a geographic area. If content is marked as having a geographic restriction, the content-protected home network will then only play that content on those devices that are in the appropriate, or authorized geographic region. Devices in the content-protected home network can be physically located all over the country, but geographically restricted content will only be played in the appropriate geographic region. This feature of the present invention applies, for example, to television broadcasts.

Many methods may be used to determine the physical location of a device. In one embodiment, the user specifies the location of devices that might play geographically limited content, such as televisions. If the user does not provide a location for the device, the device will not play geographically sensitive content. If the location of the device does not match the geographic region required by the content, the device will not play the content. If the geographic region of the content and the location of the device match, the device will play the geographically sensitive content.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a content and device removal system of the present invention can be used;

FIG. 2 is a block diagram of the high-level architecture of the content and device removal system of FIG. 1;

FIG. 3 is a process flow chart illustrating a method of operation of the content and device removal system of FIGS. 1 and 2 in removing a device from a content-protected home network;

FIG. 4 is a block diagram of the high-level architecture for maintaining a list of deleted content by the content and device removal system of FIGS. 1 and 2;

FIG. 5 is a process flow chart illustrating a method of operation of the content and device removal system of FIGS. 1 and 2 in removing content from a content-protected home network;

FIG. 6 is a process flow chart illustrating a method of providing the content and device removal system of FIGS. 1 and 2 with a secret network ID;

FIG. 7 is a block diagram of the high-level architecture of the content and device removal system of FIGS. 1 and 2 with a web server joining the content-protected home network as a device;

FIG. 8 is a process flow chart illustrating a method of operation of the content and device removal system of FIGS. 1 and 2 in verifying the integrity of network files and values;

FIG. 9 is a process flow chart illustrating a method of operation of the content and device removal system of FIGS. 1 and 2 in accepting a new key management block; and

FIG. 10 is a process flow chart illustrating a method of operation of the content and device removal system of FIGS. 1 and 2 in playing content restricted to a geographical region only in the appropriate region.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Internet: A collection of interconnected public and private computer networks that are linked together with routers by a set of standard protocols to form a global, distributed network.

World Wide Web (WWW, also Web): An Internet client—server hypertext distributed information retrieval system.

Content: copyrighted media such as music or movies presented in a digital format on electronic devices.

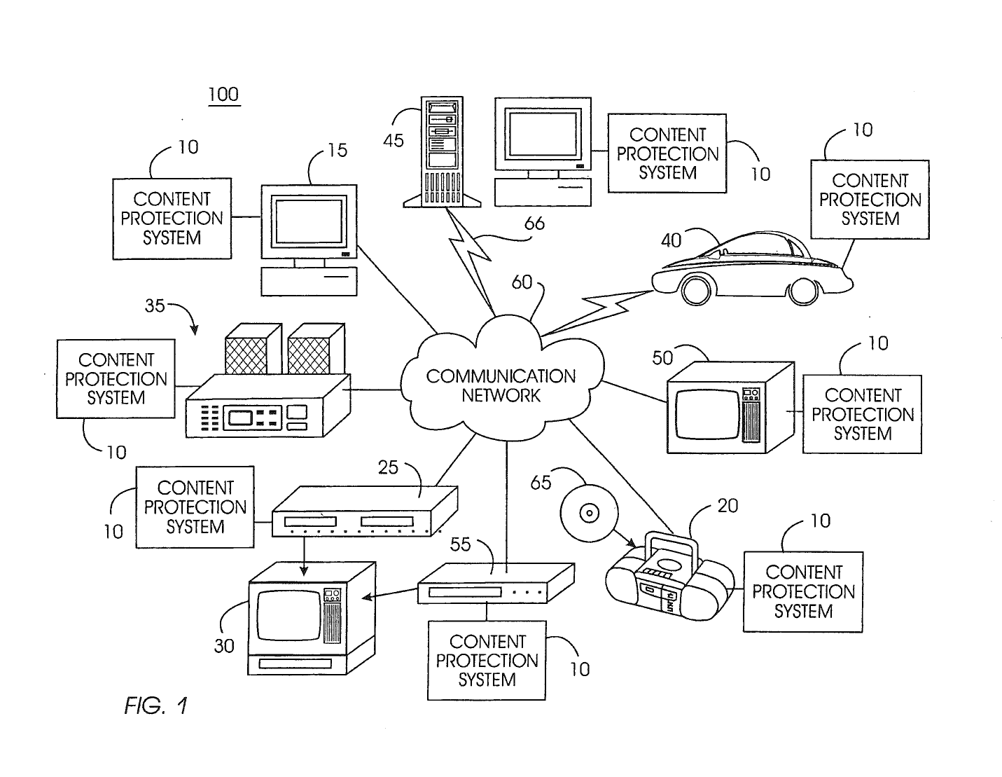

FIG. 1 illustrates an exemplary high-level architecture of a content-protected home network system 100 comprising a content protection system 10. Content protection system 10 comprises a software programming code or a computer program product that is typically embedded within, or installed on an electronic device such as, for example, a computer 15, a compact disc player (e.g., CD or DVD) 20, a cable set-top box 25 for television 30, a home stereo system 35, a car stereo system 40, a web server 45, a television 50, a digital video disc player 55, and other devices such as a game console. Alternatively, content protection system 10 can be saved on a suitable storage medium such as a diskette, a CD, a hard drive, or like devices.

Content protection system 10 may be used with any electronic device that plays, displays, or otherwise provides content, such as motion pictures, television, radio programs, etc.

Devices within the content-protected home network 100 such as the computer 15, the compact disc player 20, the cable-television set-top box 25, the home stereo system 30, the television 45, and the digital video disc player 45 communicate with one another via communication network 60. Communication network 60 may be comprised of Ethernet, cable, wireless, Internet, or any other method by which the devices within the content-protected home network 100 may communicate. The web server 45 may be connected to the communication network 60 via a communications link 66 such as a telephone, cable, or satellite link. Content may be downloaded to the car stereo 40 by means of communications link 70 such as a wireless transmission link.

Content may be purchased and downloaded from a web server 45 via the Internet. Copies of this content may then be made in a form such as compact disk 65 to play on devices such as compact disk player 20.

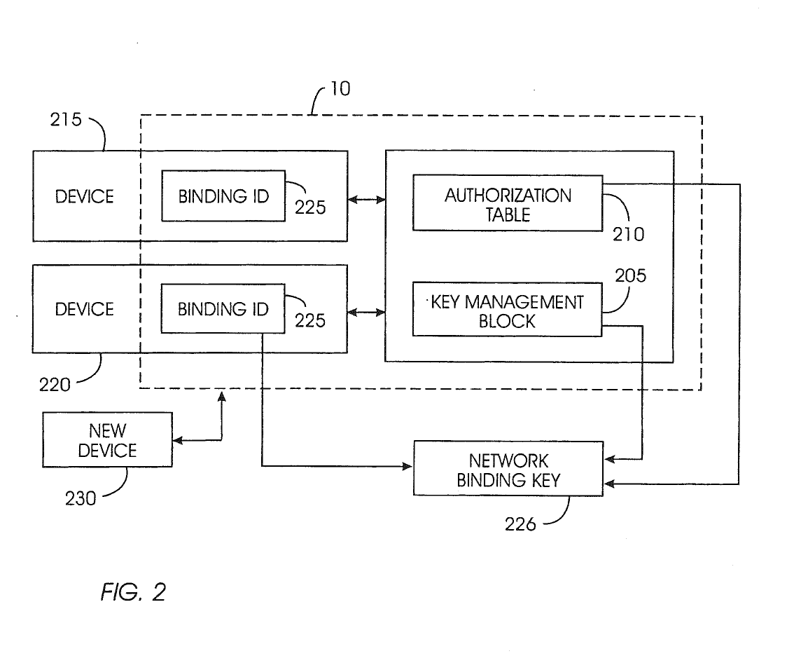

FIG. 2 illustrates a high-level architecture of the content protection system 10. The content protection system 10 comprises a key management block (KMB) 205 and an authorization table 210. A fundamental mechanism for broadcast encryption is the key management block 205, which is similar to a maze. Each device 215, 220 follows a different path in the key management block 205. Devices 215, 220 obtain the same answer, the management key, from the key management block 205 because they are legitimate, authorized devices. Unauthorized devices or circumvention devices attempt to follow the path, but are blocked from calculating the correct answer and cannot obtain the management key.

The authorization table 210 provides a common idea of which other devices are on the content-protected home network. The authorization table 210 comprises a list of all devices 215, 220 currently operating in the content-protected home network 100. In addition, the authorization table 210 comprises a list of all devices 215, 220 that have been removed from the content-protected home network 100.

Each device 215, 220 maintains its own copy of a common network identifier called the binding ID 225. The key management block 205, the authorization table 210, and the binding ID 225 are bound together cryptographically. The management key from the key management block 205, the binding ID 225, and a hash of the authorization table 210, are used to calculate a common network key, called the network binding key 226, which is also referred to herein as the encryption key.

The network binding key 226 protects all the content in the content-protected home network 100 from unauthorized use. Certain efficiencies are provided through a level of indirection: the network binding key 226 encrypts the title keys for each piece of content, and the title keys are used to actually encrypt the content itself. This level of indirection is optional, and provides efficient re-encryption when the binding key changes.

Devices 215, 220 within the content-protected home network 100, can calculate the network binding key 226 without having a conversation with each other or with any other device on the network (for example, without a handshake). This strength of the content-protected home network 100 contributes to its flexibility regarding network transport. The key management block 205 and the authorization table 210 are simple files in the network. Duplicates of the key management block 205 and the authorization table 210 may even be stored in the local persistent storage of the devices 215, 220.

The device 215, 220 knows the binding ID 225 and can obtain the key management block 205 and access the authorization table 210. Consequently, the device 215, 220 has the necessary factors needed to decrypt any piece of content in the content-protected home network 100. However, the usage rules that are cryptographically bound to that content may forbid the device 215, 220 from performing certain operations with the content. Consequently, the device 215, 220 will not perform the forbidden action because the device 215, 220 is compliant. For example, a recorder will not record a content that is encoded “do not copy”.

When a consumer purchases a new device 230 and connects it the content-protected home network 100, the new device 230 automatically transmits a broadcast message to other devices 215, 220 in the content-protected home network 100. This broadcast message is transmitted to determine which other devices 215, 220 are currently in the content-protected home network 100.

Some of the devices 215, 220 will respond to the new device 230 that they are “authorizers” and can authorize the new device 230 to be a member of the content-protected home network 100. Some of the devices 215, 220 will respond that they are “KMB servers”, meaning they have a copy of the key management block 205 and can share it with the new device 230. In practice, authorizers and KMB servers are usually the same devices. Any device 215, 220 with persistent storage will most likely choose to be both an authorizer and a KMB server.

The new device 230 asks all the authorizers to authorize it by sending an “authorize me” message to each authorizer. In this message, the new device 230 identifies itself and its electronic device type, and “signs” the message with a message authentication code. The message identification code is based upon the management key in the key management block 205. By checking the message identification code, the authorizer is confident that this new device 230 is not a circumvention device.

The new device 230 may be authorized by all of the authorizers or by only one of the authorizers. The authorizers in the content-protected home network inform the new device 230 of the binding ID 225 that is encrypted in a key based on the management key.

The authorization table 210 is changed to include the new device 230. The authorization table 210 is part of the calculation of the network binding key 226. The authorizers communicate with each other, notifying each other that there is a new network binding key 226. In addition, content is re-encrypted. Advantageously, only the title keys need to be re-encrypted. Title keys are typically only a few bytes long.

The new device 230 may have persistent storage and is prepared to become another authorizer and KMB server on the network. In this case, the new device 230 will have its own key management block 205 pre-installed. The new device 230 does not want to just blindly accept the key management block 205 that is currently in use.

The key management block 205 might be an old key management block 205 that has been compromised. In addition, devices 215, 220 might be a group of circumvention devices designed to obtain new key management blocks 205 to start obtaining new content.

To maintain content protection, system 10 adapts the key management block 205 of the new device 230 as the key management block 205 of the content-protected home network 100.

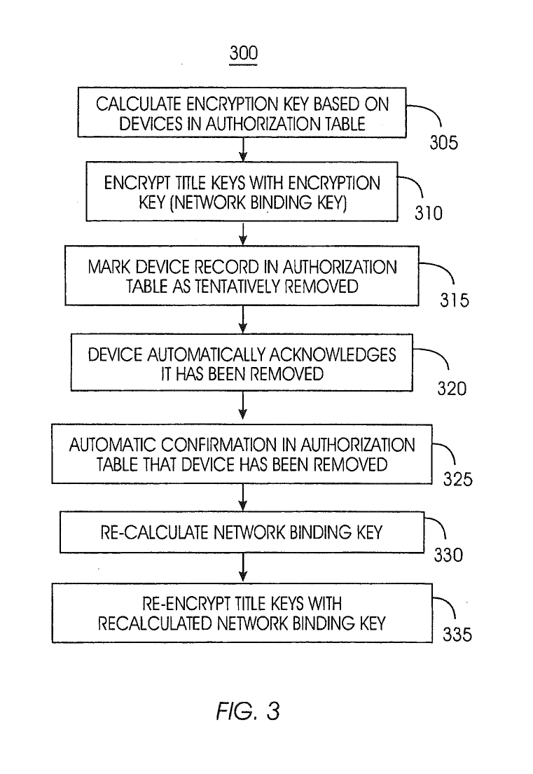

FIG. 3 illustrates a method 300 for removing a device from a content-protected home network 100. In normal operation, system 10 calculates an encryption key based on the device list stored in the authorization table 210 (step 305). Content that is protected by the content-protected home network 100 is encrypted with this key at step 310. A level of indirection may optionally be included with the content title keys, as explained above. To remove a device, such as device 215, from the content-protected home network 100, system 10 marks the record for the device in the authorization table 210 as tentatively removed (step 315).

The device 215 being removed, automatically acknowledges it has been removed at step 320. The acknowledgment message from the device 215 being removed has a cryptographic property, a message authentication code. Only a compliant device can correctly give the right response at step 320.

Every device in the content-protected home network knows whether the device 215 being removed recognizes that it has been removed. This feature of system 10 prevents adversaries from pretending to remove a device from the system to circumvent a size limit imposed on the content-protected home network. For example, the size of the content-protected home network may be restricted to ten devices to prevent the content-protected home network from encompassing an entire college dormitory or an entire neighborhood.

System 10 marks the record for the removed device 215 in the authorization table 210 as being removed rather than tentatively removed. The record for the removed device 215 remains in the authorization table 210. Once the device 215 is removed, it is no longer counted against the maximum devices allowed by the content-protected home network.

Because the authorization table 210 has changed, the calculation of the hash of the authorization table 210 is now different. The network binding key is also different, and is recalculated in step 330. In step 335, the title keys are re-encrypted the new network binding key 226.

Title keys are small, and this re-encryption process takes very little time. Any time the network binding key 226 changes, the devices tell each other about the change in case a device was not powered on when the change occurred.

A device 215 that has been removed from a content-protected home network 100 knows it is no longer a part of that content-protected home network 100, and cannot play a content that was part of the content-protected home network 100. This feature of system 10 is possible because the record for the device remains in the authorization table 210, marked as removed. Consequently, even if the removed device 215 had a hard disk filled with content, the removed device 215 will not play the content.

An unauthorized user may, for example, wish to sell the device 215 and all its content, while keeping access to the content on his or her content-protected home network 100. The foregoing feature of system 10 will not allow this scenario to occur because the binding key for that content includes the authorization table 210, indicating that the device 215 is no longer a part of the content-protected home network 100.

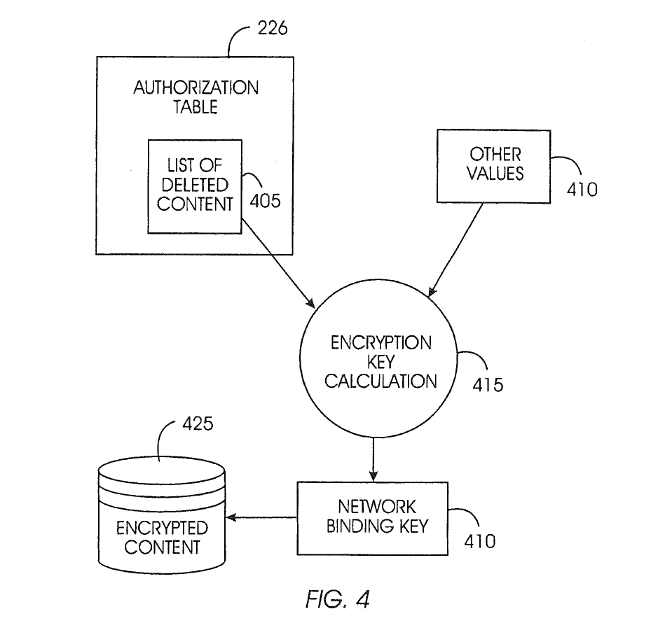

To provide users with a mechanism for selling or giving away content, system 10 maintains a list of deleted content, as illustrated in FIG. 4. A list of deleted content 405 is maintained in the authorization table 210. Content that is not deleted is not included in the authorization table 210.

System 10 uses the list of deleted content 405 and other values 410 (such as the key management block 205 and the binding ID 225) in the key calculation 415, to calculate an network binding key 226. The network binding key 226 is used to encrypt content, creating encrypted content 425.

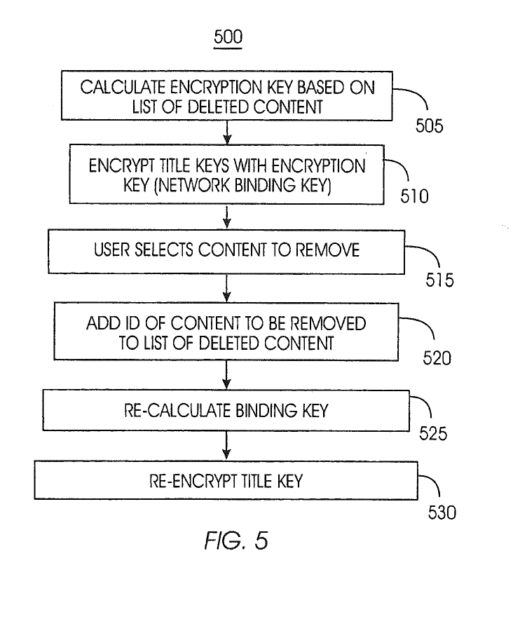

FIG. 5 illustrates a method 500 of removing content from the content-protected home network 100. In one embodiment, a list of content that has been removed from the content-protected home network 100 is maintained in the authorization table 210.

In normal operation, system 10 calculates the network binding key 226 based on the list of deleted content 405, at step 505. At step 505, the list of deleted content 405 is comprised of all the content that has previously been deleted in the content-protected home system 100. System 10 encrypts the title keys of the protected content in the network with the network binding key 226 (step 510).

The user selects the content to be removed from the system at step 515. System 10 adds the identifier (ID) of the newly deleted content to the list of deleted content 405 (step 520). The network binding key 226 has now been changed because the list of deleted content 405 in the authorization table 210 has been changed. System 10 recalculates the content key and binding ID 225 at block 525 and re-encrypts the title keys of the content at block 530.

The encryption for all of the content in the content-protected home network 100 now changes because of the deletion of one item of content. If the user attempts to keep a copy of the content he is giving to a friend or selling, the title key for that piece of content is no longer correctly encrypted. System 10 will note that the title key for that piece of content cannot be decrypted by the network binding key 226. Consequently, system 10 will not play the content on any of the devices in the content-protected home network.

For example, a user electronically purchases a movie through the Internet and downloads the movie to his content-protected home network 100. This movie is now stored electronically on network storage in the content-protected home network 100. The user decides to sell the movie to a friend, and burns the movie onto a protected DVD recordable disc. The content-protected home network 100 knows that the user is moving the movie out of network storage to the protected DVD recordable disc.

System 10 notes in the list of deleted content 405 that the movie is no longer in the content-protected home network 100. This changes the authorization table 210, and system 10 recalculates the binding ID 225 and re-encrypts all the content in the content-protected home network 100. The title key corresponding to the movie that has been sold is not re-encrypted. Even if the user kept a copy of the movie in storage in the content-protected home network 100, none of the devices in the content-protected home network 100 will play the movie.

A user might, for example, make a backup compact disc of music the user had purchased and downloaded from the Internet. The user can legally make backup copies of content for his use. However, the user might attempt to make an extra copy for a friend. This copy will not play on the content-protected home network 100 of the friend because it has a different network binding key 226. This feature of system 10 prevents distribution of protected content on the Internet.

The fundamental assumption of system 10 is that a user has purchased the rights to content only for the content-protected home network 100 of the user. Even if the content is erased it in the content-protected home network 100, the user may have made backup copies of the content. The user might attempt to restore the deleted content from a backup copy. Using the list of deleted content 405 and the encryption techniques of system 10, system 10 prevents the backup copy from being played on the content-protected home network 100.

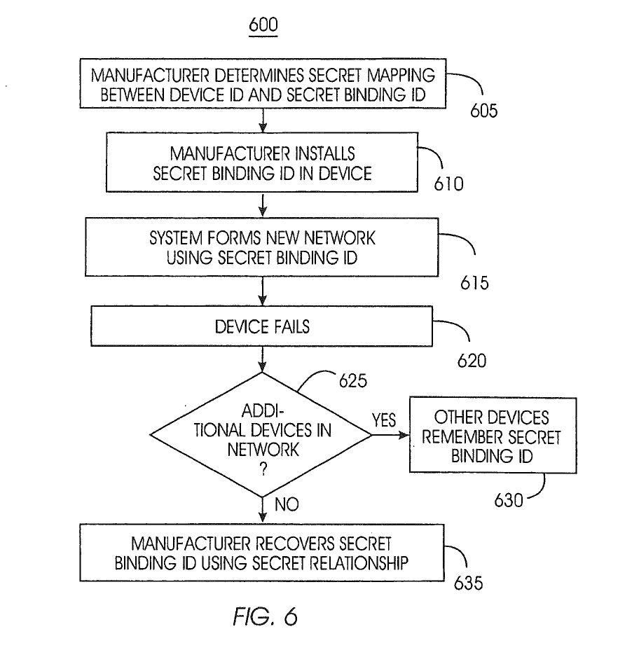

System 10 provides a content-protected home network 100 with a secret network ID, as illustrated by a method 600 of the process flow chart of FIG. 6. The device manufacturer at step 605 determines the secret binding ID 225 of a device in the content-protected home network. Only the manufacturer knows the secret binding ID 225 for each device. The secret binding ID may be, for example, a result of a mapping between the device ID and the secret binding ID 225 or the use of a secret cryptographic key to transform the device ID. The manufacturer installs the secret binding ID 225 in the device at step 610.

The first device installed in a content-protected home network 100 uses its secret binding ID 225 as the binding ID for the content-protected home network 100 to form the new network (step 615). The secret binding ID 225 is shared among all the devices in the content-protected home network 100. Devices that join the network later use the first device's binding ID.

A device may fail at step 620. If other devices are in the content-protected home network 100 (decision step 625), the other devices in the content-protected home network 100 will remember the secret binding ID at step 630. The secret network ID can be used to insert a new device in the content-protected home network 100, allowing continued usage of all content in the content-protected home network 100.

However, a content-protected home network 100 may comprise only one device at decision step 625. If the device fails, the user has no means for restoring his content-protected home network 100 or his content. System 10 provides a mechanism for restoring a secret binding ID in the case of a device failure. In one embodiment, the manufacturer provides the secret binding ID to the user based on a secret relationship between the serial number of the device and the secret binding ID (step 635).

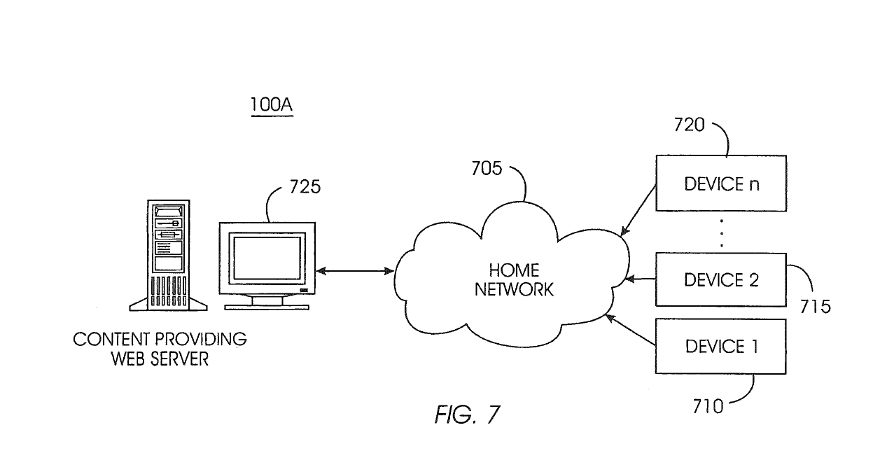

In another embodiment, a web server that is delivering content such as movies or music to the home becomes part of the content-protected home network 100 as illustrated by FIG. 7. A content-protected home network 100A with secret binding ID comprises a network 705 and one or more devices such as device 1, 710, device 2, 715, through device n, 720. A content-providing web service 725 joins the content-protected home network 100A as a device. The identification message provided to the content-protected home network 100A by the content-providing web service 725 comprises an integrity message to prevent unauthorized use of the content-protected home network 100A.

System 10 marks the content-providing web service 725 as a “provider” and provides the secret binding ID 225 of the content-protected home network 100A to the content-providing web service 725. The content-protected home network 100A may comprise multiple content-providing web services 725. The content-providing web services 725 do not count against the maximum number of devices allowed in the content-protected home network 100A. The secret binding ID may be maintained in a database by the content-providing web service 725.

The content-providing web server 725 encrypts the content with the network binding key 226 for the content-protected home network 100A. This feature of system 10 makes it very convenient for users to purchase content over the Internet. The content is delivered to the content-protected home network 100A configured for immediate use. In addition, the content-providing web server 725 now remembers the secret network ID in a manner similar to other devices in the content-protected home network 100A. Consequently, the web server 725 does not have to go through the connection protocol if the user purchases further content through it.

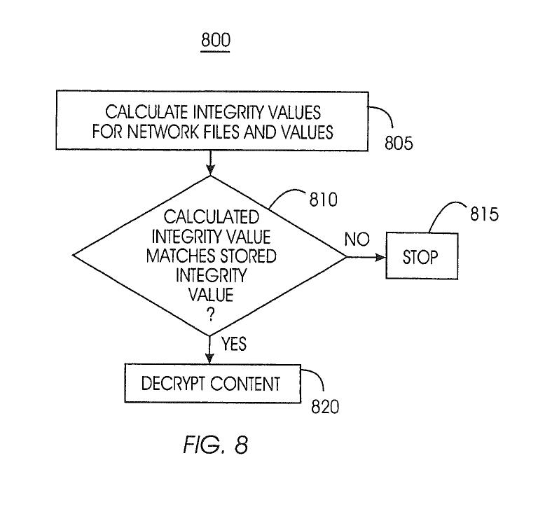

As shown in FIG. 8, System 10 further provides a method 800 for performing an integrity check on critical files in the content-protected home network 100 comprising the key management block 205, the authorization table 210, etc. A device that cannot store these critical files is susceptible to attacks from adversaries or hackers attempting unauthorized playing or copying of content. The content-protected home network 100 requires that devices have at minimum a small amount of secure read-write storage.

The purpose of this secure read-write storage is to store an integrity check value on each file for each device. Any of several methods may be used to create the integrity check value. A hash of each value may be stored in the secure storage. Alternatively, the network binding key 226 may be stored in the secure storage of the device. The network binding key 226 is the result of a calculation comprising the key management block 205 and the authorization table 210, and may be used to verify the integrity of the key management block 205 and authorization table 210 presented to the device.

System 10 provided on a device (such as device 215), calculates the integrity values of network files such as the key management block 205 and the authorization table 210 at step 805. At decision step 810, system 10 compares the calculated integrity value with the stored integrity value.

If the values match, system 10 allows the device 215 to decrypt the content at step 815. If the values do not match, system 10 stops at step 820 and does not allow the device 215 to play the encrypted content. The integrity values might not match, for example, if the device 215 has been removed from the network and a hacker is attempting to restore the state of the network before the removal occurred, in order to play the original network's content on the removed device 215.

System 10 provides a method for updating key management blocks 205 that replaces an old key management block 205 with a new key management block 205 rather than merging the new key management block 205 with the old key management block 205. Key management blocks 205 are updated on a regular basis to minimize the effectiveness of circumvention devices.

The key management block 205 maintains a list of circumvention devices that are not allowed to operate in a content-protected home network 100. This list of revoked circumvention devices is updated regularly.

As new key management blocks 205 are released, content-protected home networks adopt the newer key management block 205. In one embodiment, the key management blocks 205 are digitally signed; consequently, the key management block 205 cannot be undetectably modified.

A digitally signed key management block 205 may comprise a release date. A hacker might wish to change the release date to get a content-protected home network 100 to accept a compromised key management block 205. However, the release date cannot be changed without invalidating the digital signature. Devices simply check the signature to make ensure the key management block 205 is intact. The device can then trust the key management block 205 and the date in the key management block 205.

In a further embodiment, the key management block 205 may comprise a revision number. System 10 will not accept the new key management block 205 unless the revision number is higher than the revision number of the current key management block 205.

In an alternate embodiment, system 10 may compare two key management blocks 205. A newer key management block 205 will comprise more revoked circumvention devices. Consequently, the key management block 205 with more revoked circumvention devices is the newer key management block 205. Logically, system 10 determines if the existing key management block 205 is a subset of the newer key management block 205. If so, system 10 adopts the newer key management block 205.

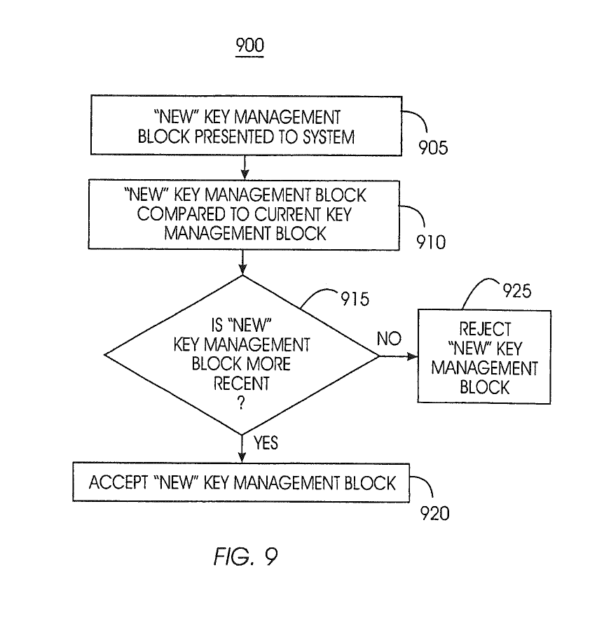

A method 900 for determining whether a key management block 205 is newer than the existing key management block 205 is illustrated by the process flow chart of FIG. 9. A “new” key management block 205 is presented to system 10 at step 905.

System 10 uses comparison logic to compare the “new” key management block 205 with the current key management block 205 at step 910. The comparison logic may, for example, compare dates in a digitally signed key management block 205 or compare the number of revoked devices in the key management blocks 205.

If the “new” key management block 205 is more recent than the current key management block 205 at decision step 915, system 10 accepts the “new” key management block 205 at step 920, replacing the current key management block 205 with the “new” key management block 205. Otherwise, system 10 rejects the “new” key management block 205 at step 925.

System 10 provides a mechanism for restricting content to a geographic area. If content is marked as having a geographic restriction, the content-protected home network 100 will then only play that content on those devices that are in the appropriate geographic region. Devices in the content-protected home network 100 can be physically located all over the country, but geographically restricted content will only be played in the appropriate geographic region. This feature of the system 10 applies, for example, to television broadcasts.

Many methods may be used to determine the physical location of a device. In one embodiment, the user specifies the location of devices that might play geographically limited content, such as televisions. To prevent unauthorized use by the user, system 10 may limit the number of times a user may change the location of the device. In another embodiment, the location of the device is determined based on its connection to a service such as cable television, satellite television, etc.

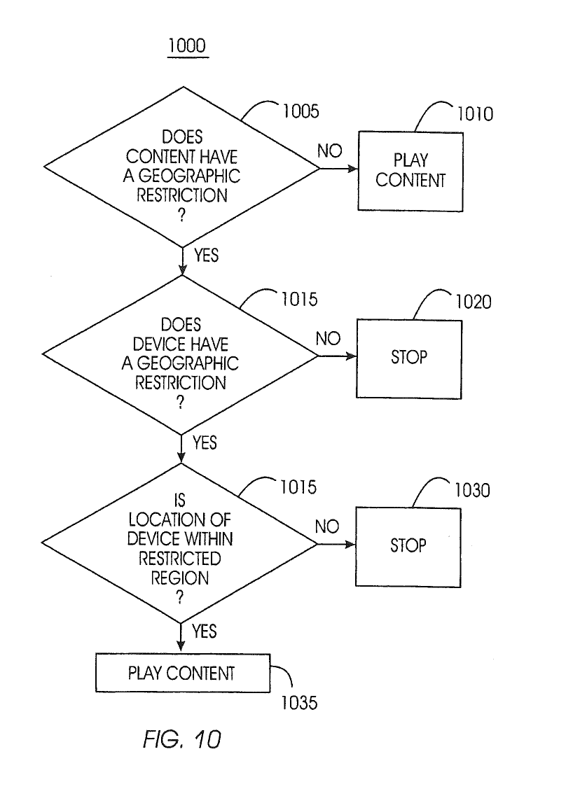

In a further embodiment, the location of the device is determined from an internal GPSS receiver. A method 1000 for determining whether a device may play geographically sensitive content is illustrated by the process flow chart of FIG. 10. At decision step 1005, system 10 determines whether the content has a geographic restriction. If not, system 10 plays the content at step 1010.

If the content has a geographic restriction (decision block 1005), system 10 then determines whether the device has a specified geographic location at decision step 1015. If the user does not provide a location for the device, the device will not play geographically sensitive content (step 1020).

If the location of the device does not match the geographic region required by the content at decision step 1025, the device will not play the content (step 1030). Otherwise, the geographic region of the content and the location of the device match at decision step 1025 and the device will play the geographically sensitive content at step 1035.

It is to be understood that the specific embodiments of the invention that have been described are merely illustrative of certain applications of the principle of the present invention. Numerous modifications may be made to a system and method for securely removing content or a device from a content-protected home network described herein without departing from the spirit and scope of the present invention. Moreover, while the present invention is described for illustration purpose only in relation to the Internet, it should be clear that the invention is applicable as well to, for example, to a local area network, a wide area network, or any network in which electronic devices or computers may communicate.

1. A method for maintaining an integrity of a network containing a plurality of devices, the method comprising:
calculating an integrity check value for network files and network values;
comparing the calculated integrity check value to a saved integrity check value, to determine if any one of the network files and the network values has changed;
calculating an encryption key on the network files and network values; and
decrypting a protected content in the network using the encryption key.

2. The method of claim 1, wherein the network files comprise a file that contains a list of removed files.

3. The method of claim 2, wherein the network files further comprise a file that contains a list of deleted content.

4. The method of claim 3, wherein the files that contain the lists of removed files and deleted content are stored in at least two different datastores.

5. The method of claim 4, wherein the files that contain the lists of removed files and deleted content are contained in an authorization table.

6. The method of claim 5, wherein the network files contain a key management block.

7. The method of claim 5, wherein the network values contain a device binding ID.

8. The method of claim 1, wherein the integrity check value contains the encryption key.

9. The method of claim 1, further comprising restricting playback of a protected content in the network.

10. The method of claim 9, wherein restricting the playback of the protected content in the network comprises determining if the protected content has an associated geographic restriction.

11. The method of claim 10, wherein restricting the playback of the protected content in the network further comprises determining if a device to play the protected content has an associated geographic limitation.

12. The method of claim 11, wherein restricting the playback of the protected content in the network further comprises preventing the playback of the protected content if the geographic restriction of the protected content is not met.

13. The method of claim 11, wherein restricting the playback of the protected content in the network further comprises preventing the playback of the protected content if the geographic limitation of the device to play the protected content is not met.

14. The method of claim 11, further comprising determining a geographic location of the device to play the protected content.

15. The method of claim 14, wherein determining the geographic location of the device to play the protected content comprises determining the geographic location based on a connection of the device to a cable service.

16. The method of claim 14, wherein determining the geographic location of the device to play the protected content comprises determining the geographic location based on an internal GPS receiver.

17. The method of claim 14, wherein determining the geographic location of the device to play the protected content comprises querying a user about the device geographic location.

18. The method of claim 14, further comprising placing a limitation on the number of times the geographic location of the device may be changed.

19. A system for maintaining an integrity of a network containing a plurality of devices, the system comprising:
an integrity check value that is calculated for network files and network values;
the calculated integrity check value being compared to a saved integrity check value, to determine if any one of the network files and the network values has changed;
an encryption key that is calculated on the network files and network values; and
a protected content being decrypted in the network using the encryption key.

20. The system of claim 19, wherein the network files comprise a file that contains a list of removed files.
